(19) United States
(12) Patent Application Publication
(10) Pub. No.: US 2005/0041014 A1
(43) Pub. Date: Feb. 24, 2005

(54) Using cursor immobility to suppress selection errors

(76) Inventor: Benjamin Slotznick, Mt. Gretna, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/919,646

(22) Filed: Aug. 17, 2004

Related U.S. Application Data
(60) Provisional application No. 60/497,094, filed on Aug. 22, 2003.
(60) Provisional application No. 60/499,917, filed on Sep. 2, 2003.

(51) Int. Cl. G09G 5/00

(52) U.S. Cl. 345/156

(57) ABSTRACT

Detection of when a cursor on a display screen being moved by a pointing device comes to a deliberate stop is performed by detecting the position of the cursor at successive intervals of time, comparing the current cursor position to the cursor position at the previous interval of time at each interval of time, and detecting that the cursor has come to a deliberate stop by detecting when the difference between the current cursor position and the cursor position at the previous interval of time is less than a predetermined value. Activation of an object on a display screen may be conditioned upon the cursor coming to a deliberate stop on the object.

### CROSS-REFERENCE TO RELATED APPLICATIONS

This application claims the benefit of U.S. Provisional Application No. 60/497,094 filed Aug. 22, 2003 and U.S. Provisional Application No. 60/499,917 filed Sep. 2, 2003.

### BACKGROUND OF THE INVENTION

Many people have difficulty reading, and need the help of screen readers to understand text displayed on a computer screen. Reading difficulties can arise from low vision, dyslexia, cognitive disabilities (such as mental retardation), poor schooling, and other causes. One-fifth of American adults are functionally illiterate.

At least one screen reader (e.g., a screen reader called the Point-and-Read screen reader, U.S. patent application Ser. No. 10/084,582, also, U.S. Published Application No. 2002/0178007 published Nov. 28, 2002, incorporated herein by reference) has users select the sentence to be read by putting the computer cursor over that sentence. Selection occurs when the user lets the cursor (or mouse) hover over the sentence for a pre-specified amount of time. This differs from most screen readers which require the user to click on a sentence to select it for reading, or to tab to that sentence. The Point-and-Read screen reader is intended to also help people who may have hand motor disabilities as well as reading difficulties.

Many people have problems with hand motor control. There are many causes of such conditions, including nerve damage and muscular degeneration, and such conditions are manifest in many ways. These difficulties can include problems of dexterity, fine motor control, inability to grasp, limited range of motion, digital strength or coordination, and tremors. The limitations may relate to the whole arm, just the wrist or even single digits.

Some people with hand-motor-control disabilities sometimes have difficulty triggering on-screen objects when using a computer pointing device. This may occur when the user wants to put the pointer over an object but the object is too small for the user to accurately target. Sometimes the user can bring the pointer over an object, but cannot hold the pointer steady over that object. Sometimes the user cannot precisely stay on a defined path (or stay within a defined area surrounding that path) when the user moves the pointer from one place on the screen to another. Sometimes the user cannot keep the mouse pointer steady while pressing a button on the mouse.

Some people with hand-motor-control disabilities sometimes inadvertently trigger on-screen objects when using a computer pointing device. Cursor fluctuation in position during the user's attempts to target a desired object may inadvertently activate other objects that the cursor moves over. Cursor movements outside an area may trigger unintended other objects. Involuntary cursor movements outside a path from one object to another (or movements outside an area surrounding that path) may trigger unintended other objects. Slow cursor movement, based at times on attempts to be accurate and deliberate, may trigger objects over which the cursor inadvertently “lingers.” (In other words, if a user moves the cursor too slowly from one place to another, this may inadvertently linger over an intervening object long enough to trigger that object.)

Increasing target size can help, but does not eliminate these problems. Increasing the lag time before triggering can help, by allowing time to correct mistakes, but does not eliminate these problems. Separating triggering from cursor movement through clicking a button or switch, and providing prompts if necessary, can help individuals with sequencing issues, but does not eliminate these problems. The Point-and-Read screen reader uses larger task bar buttons, larger radio buttons and check boxes, and larger mouse-over objects. This Point-and-Read screen reader allows users to set preferences which vary lag times or wait times for triggering different types of objects. Different lag times can be assigned for different types of objects. Many individuals with motor problems have difficulty clicking on a computer mouse without jerking the pointer off the target object, so the Point-and-Read screen reader allows another physically-separated button (such as a space bar or other switch) to act as a mouse button. However, this is not a viable alternative to some with range of motion disabilities. The Point-and-Read screen reader also allows users to set preferences for giving verbal prompts (i.e., certain actions suggesting a user error will elicit a pre-recorded voice recording, reminding the user what to do or asking the user to verify what was intended). Yet individuals having developmental and motor disabilities still trigger unintended objects. This unintended triggering is sporadic but frequent enough to cause disorientation and confusion.

Mouse-over (mouseover) commands activate a function or call a method when the, cursor moves over an object, even if the cursor does not come to rest on the object. Essentially, a set of coordinates define the area occupied by the object on the computer screen and when the co-ordinates that define the point-location of the cursor fall within that area, the mouse-over event for that object is triggered. Correspondingly, when the cursor leaves the area (i.e., leaves the object), the mouse-out (mouseout) event is triggered. Mouse-over and mouse-out events are implemented in a variety of languages and environments including HTML, Java, and JavaScript. These languages are useful in programming screen readers to read Internet web pages and HTML documents.

One can use the mouse-over and mouse-out events to have the function or method invoked when the cursor hovers over an object for a pre-specified amount of time. Start a timer when the mouse-over event occurs, abort the timer when a mouse-out event occurs, and invoke the function or method if the timer reaches the pre-specified time without being aborted.

Similarly, in the Windows programming environment, the Windows derived class associated with an object sends the “mouse-hover” message when the cursor remains over an object, within a pre-defined rectangle for a pre-specified amount of time. In this environment, the Windows derived class also sends a “mouse-leave” message when the cursor leaves the object and a “mouse-move” message when the cursor first moves over the object. Unlike the mouse-over event (or associated command) the mouse-move message is sent with every instruction cycle as long as the cursor continues to move within the object. The message is not sent when the cursor is not moving.

Use of mouse-over commands presents some obstacles to people with hand-motor disabilities. If the cursor is positioned near an object, but not over it, but the person holding the cursor has hand tremors, the small variations in cursor location may move on and off the nearby object, triggering the mouse-over event for that object unintentionally and even repeatedly. Just as inhibiting, if the cursor is intentionally positioned over an object, small hand tremors may cause the cursor to move on and off the object repeatedly, initiating multiple new mouse-over events when only one is intended. This may activate code associated with that object repeatedly, when the user intended to activate the code only once. Likewise, if the user moves the cursor over one end of a long and narrow object intending to trigger a mouse-over event, and then moves the cursor from one end of the object to the other, intending to stay within the boundaries of the object so that no new mouse-over event occurs, motor-control disabilities may cause the user's hand to move in a more sinusoidal motion, moving on and off the object. This may initiate multiple new mouse-over events, and may repeatedly activate code associated with the object, when only one activation was intended.

Many people with motor control disabilities can release the pointing device once it is positioned correctly. This can occur by letting go of a mouse, or lifting a hand or finger off the track ball. In this way, a disabled user can stop the cursor.

The “tool tip” feature of Windows shows a text message when the cursor has stopped over an object (and a message had been previously coded for that object). For example, an icon description “Open Footer” appears after the mouse has hovered over the footer icon in Microsoft Word for more than about a second.

### BRIEF SUMMARY OF THE INVENTION

In its broadest embodiment, the present invention provides a scheme for detecting when a cursor on a display screen being moved by a pointing device comes to a deliberate stop. Operation proceeds as follows:
1. Detect the position of the cursor at successive intervals of time.
2. At each interval of time, compare the current cursor position to the cursor position at the previous interval of time.
3. Detect that the cursor has come to a deliberate stop by detecting when the difference between the current cursor position and the cursor position at the previous interval of time is less than a predetermined value.

The present invention teaches a mouse-stop event as well as methods of using a mouse-stop event as a pre-condition for activating objects or triggering actions. When coupled with mouse-over commands, people with hand-motor disabilities can use a computer mouse, with fewer activation errors. In particular, such individuals with reading difficulties can use a screen reader (such as the Point-and-Read screen reader) more accurately.

A “mouse-stop event” is first defined to be when the cursor comes to a complete stop and does not move. In terms of vector analysis, it could be said that the direction and speed of cursor movement are described by the “null vector” or “zero vector”. A “mouse-start event” is defined to be when the cursor begins moving again.

In most practical applications, the phrase “does not move” has to be defined with respect to a time period during which non-movement is ascertained (or movement is measured). In many instances this will be based on the basic instruction cycle time period or the refresh time of the computer monitor. In other instances it will be based upon the sampling time for the cursor input device (such as a mouse, trackball, touch pad, joystick, etc.). In most practical applications, the phrase “does not move” also has to be defined with respect to the spatial coordinates over which non-movement is ascertained (or movement is measured). In many instances this will be the dimensions of a pixel on the monitor. In other instances it may be the less than minimum sensitivity of spatial movement for the cursor input device (such as a mouse, trackball, touch pad, joystick, etc.).

Practical implementation of a mouse-stop event requires a specification of both a minimum time period and spatial distance over which non-movement is ascertained or (movement is measured).

While some people have hand tremors, the amplitude and duration of the tremors will vary from individual to individual. An individual with tremors may try to keep the mouse or other cursor input device steady, but may be unable to. This leads to the second definition of a “mouse-stop event”.

A “mouse-stop event” is secondly defined to be when the cursor comes to a relative stop, in that the cursor remains within a small area of pre-specified dimensions (e.g. within an epsilon distance from some point, or within a pre-defined rectangle centered on a point), for a minimum pre-specified time period. Under this definition, user preferences (or a programmer's preferences) can determine what the computer will consider as a mouse-stop event. In a given application, the parameters which specify the small area or minimum time period may have exposed APIs or may be hidden in inaccessible source code or compiled code. The small area may be any shape, including square, rectangular, or circular. It may be defined as centered on the cursor's position at any moment. It may be defined as having to persist unchanged over the pre-specified time period, or it may drift with small cursor movement.

The present invention may be embodied as a software program, including but not limited to a software module, library, plug-in, add-on, extension, Active X component, method, or function. It may be written in any computer language, including but not limited to C++, Java, JavaScript, Basic, or Microsoft Foundation Classes.

A preferred embodiment is as an event handler in any development environment, using any computer language, including but not limited to mark-up languages such as HTML.

The present invention may be invoked as a DHTML Event, handled by a scripting language like JavaScript or VBScript. Just as the “click” event is invoked by HTML using the term “onclick”, without intending any limitation, the “mouse-stop” or “mouse-start” events may be invoked by HTML using the term “onmouse-stop” or “onmouse-start”. Other embodiments of the present invention may invoke the event handler using other terms.

### BRIEF DESCRIPTION OF THE DRAWINGS

FIGS. 1A and 1B contrast how a person who does not have hand-motor disabilities might move the cursor from one object to another, compared to how a person who has such disabilities might perform the task.

FIGS. 2A and 2B contrast how a person who does not have hand-motor disabilities might move the cursor along (and within) one object in order to get to another object, compared to how a person who has such disabilities might perform the task.

FIGS. 3A and 3B contrast how a person who does not have hand-motor disabilities might move the cursor along (and within) one object which is adjacent to another object in order to get to still another object, compared to how a person who has such disabilities might perform the task.

FIGS. 4A and 4B contrast how a person who does not have hand-motor disabilities might move the cursor off of an object and back onto it, compared to how a person who has such disabilities might perform the task.

FIG. 5 shows a flow chart of one embodiment of the present invention.

FIG. 6 shows a flow chart of another embodiment of the present invention.

### DETAILED DESCRIPTION OF THE INVENTION

Certain terminology is used herein for convenience only and is not to be taken as a limitation on the present invention. In the drawings, the same reference letters are employed for designating the same elements throughout the several figures.

In many instances, the mouse-stop event (or mouse-start event) is not useful in and of itself, but is useful as one of two or more preconditions necessary for an object to be activated, a link triggered, an application launched or a function (or method) called.

In one preferred embodiment, the preconditions are a mouse-stop event and a mouse-over event that are both timed. In other words, the computer cursor must be over an object and remain stationary for a minimum pre-specified time, in order to trigger or activate the object.

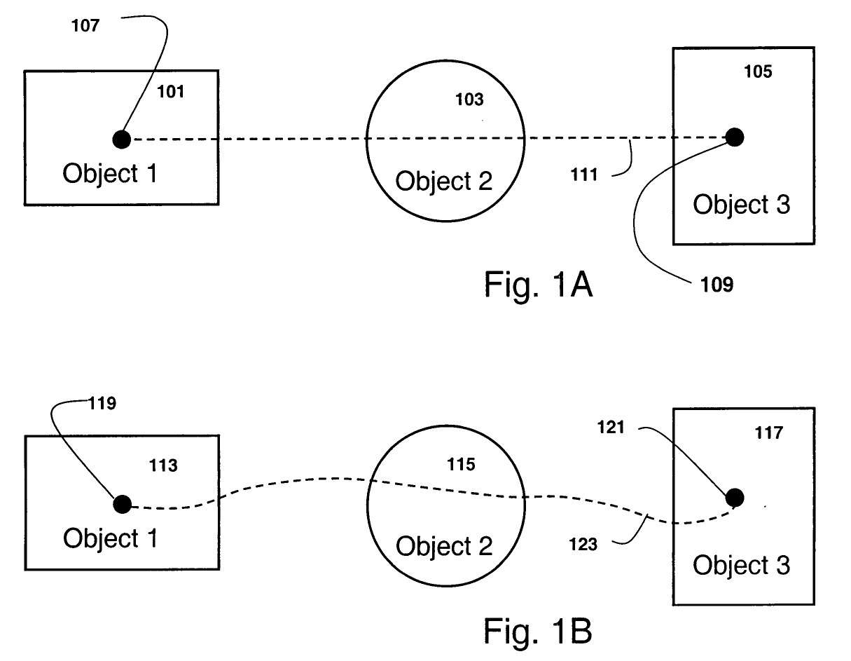

Consider FIGS. 1A through 4B. Each of these figures shows objects on a computer screen. Each object is activated when the user puts the computer cursor over that object and leaves it there for one second. Activation could start a variety of actions such as, but not limited to, make a noise, play a sound file, or read a paragraph.

Consider first FIG. 1A. This figure shows a situation when a user moves from one object to another—but must cross over an intervening object.

The user has just activated Object 1, 101, by putting the cursor at a point on the object, 107. The user now wants to activate Object 3, 105, by putting the cursor over a point, 109, on Object 3. But the user does not want to activate Object 2, 103. If the user moves the cursor from the point, 107, on Object 1, to the point, 109, on Object 3, the cursor moves along a path, 111, which crosses over Object 2, 103. For most computer users, this task takes less than a second. So even though the cursor crosses Object 2, it does not linger over Object 2 long enough to activate it.

Many people will not be able to move the cursor in a perfectly straight line from point 107 to point 109. This is illustrated in FIG. 1B.

In FIG. 1B, the user moves the cursor from a point, 119, on Object 1, 113, to a point, 121, on Object 3, 117, along a path, 123, which crosses Object 2, 115. If the user moves the cursor at a moderate speed, the cursor still does not linger over Object 2 long enough to activate it. However, if the user has certain hand-motor-control disabilities, the user will move the cursor along path, 123, in a much slower and deliberate manner. In field trials of the Point-and-Read screen reader, some individuals with motor disabilities took more than 10 seconds to follow such a path. For such users, the cursor would take more than 2 seconds to traverse over Object 2. This would activate Object 2 because the cursor remained over Object 2 for more than 1 second, even though the user was trying not to do so and even though the user did not stop over Object 2.

The present invention teaches that each of the objects in FIG. 1B, (Object 1, Object 2, and Object 3) can have as a precondition to activation, not only the mouse-over event already described, but also a mouse-stop event. To activate Object 1, 113, the user can put the cursor over a point, 119, on the object and either keep his hand steady, or let go of the cursor input device. This can be accomplished by lifting a finger off a track ball, or touch pad. In field trials of the Point-and-Read screen reader, some individuals with hand-motor control disabilities would hold a standard computer mouse between their thumb and forefinger in a light pincher movement, as if it were an eraser. (The Point-and-Read screen reader did not require any clicking of mouse buttons, so many users did not put any fingers over the mouse buttons.) When the users moved the mouse so that the cursor was over a desired object, they would move those two fingers apart, letting go of the mouse without jerking it. To activate Object 3, 117, the user moves the cursor along the path, 123, until the cursor reaches a point, 121, on Object 3, then lets go of the mouse so that the cursor stops. Even if the user moves the cursor very slowly, Object 2 is not activated because the cursor never stops over Object 2 (i.e., because the mouse-stop event does not happen, one of the preconditions for activation of Object 2 is not met).

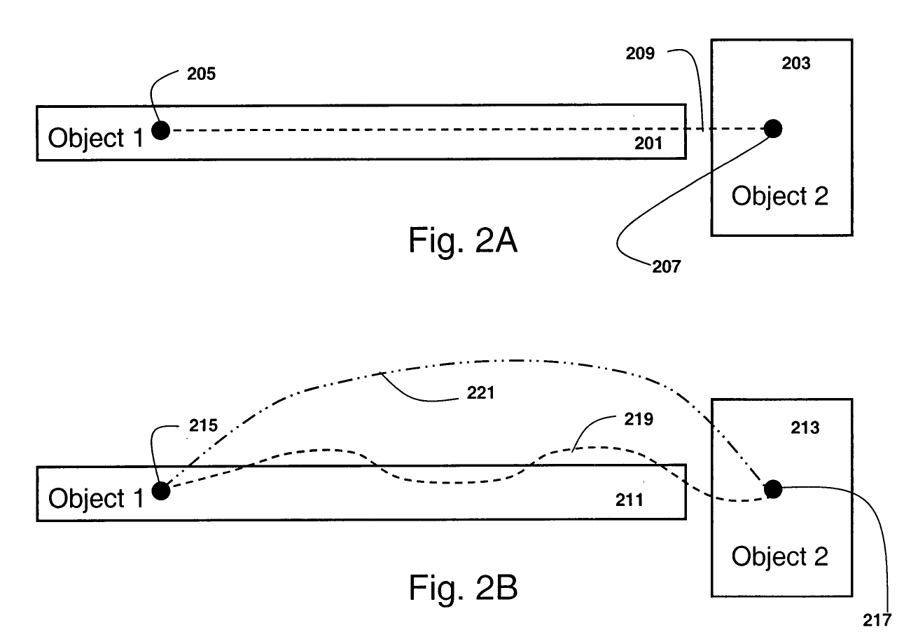

Consider now FIG. 2A, where each object (i.e., Objects 1 or 2) is activated when the cursor lingers over it for more than a second. The user has just activated Object 1, 201, by putting the cursor at a point on the object, 205. The user now wants to activate Object 2, 203, by putting the cursor over a point, 207, on Object 2. If the user moves the cursor from the point, 205, on Object 1, to the point, 207, on Object 3, the cursor moves along a path, 209, which travels within Object 1. As long as the cursor remains within Object 1, Object 1 is not activated and no other object is activated. For most computer users, this task takes less than a second. For many it can be done without the cursor path wandering outside Object 1.

Many people will not be able to move the cursor in a perfectly straight line from point 205 to point 207. This is illustrated in FIG. 2B.

In FIG. 2B, the user moves the cursor from a point, 215, on Object 1, 211, to a point, 217, on Object 2, 213, along a path, 219. Even though the cursor travels off of Object 1 and back onto it, if the user moves the cursor at a moderate speed, the cursor still does not linger over Object 1 long enough to activate it again. However, if the user has certain hand-motor-control disabilities, the user will move the cursor along path, 219, in a much slower and deliberate manner. In field trials of the Point-and-Read screen reader, some individuals with motor disabilities took more than 10 seconds to follow a path such as this. For such users, the cursor would move off Object 1 for a couple of seconds then back onto Object 1 for a couple of seconds, then off again and on again before reaching Object 2. Each time the cursor moved back over Object 1 for a second, it would activate Object 1 again, even though the user was trying not to do so. Some users, in order to prevent this reactivation of Object 1, would take an indirect path, such as 221, from a starting point, 215, on Object 1 to their destination point, 217, on Object 2.

The present invention teaches that each of the objects in FIG. 2B, (Object 1 and Object 2) can have as a precondition to activation, not only the mouse-over event already described, but also a mouse-stop event. To activate Object 1, 211, the user can put the cursor over a point, 215, on the object and either keep his hand steady, or let go of the cursor input device. This can be accomplished by lifting a finger off a track ball, or touch pad. In field trials of the Point-and-Read screen reader, some individuals with hand-motor control disabilities would hold a standard computer mouse between their thumb and forefinger in a light pincher movement, as if it were an eraser. (The Point-and-Read screen reader did not require any clicking of mouse buttons, so many users did not put any fingers over the mouse buttons.) When the users moved the mouse so that the cursor was over a desired object, they would move those two fingers apart, letting go of the mouse without jerking it. To activate Object 2, 213, the user moves the cursor along the path, 219, until the cursor reaches a point, 217, on Object 2, then lets go of the mouse so that the cursor stops. Even if the user moves the cursor very slowly, Object 1 is activated only once—the initial activation. Object 1 is not activated when path 219 crosses it because the cursor never stops during the course of the path over Object 1 (i.e., because the mouse-stop event does not happen, one of the preconditions for re-activation of Object 1 is not met). A user who moves the cursor slowly does not have to follow path 221 to avoid unintended re-activation.

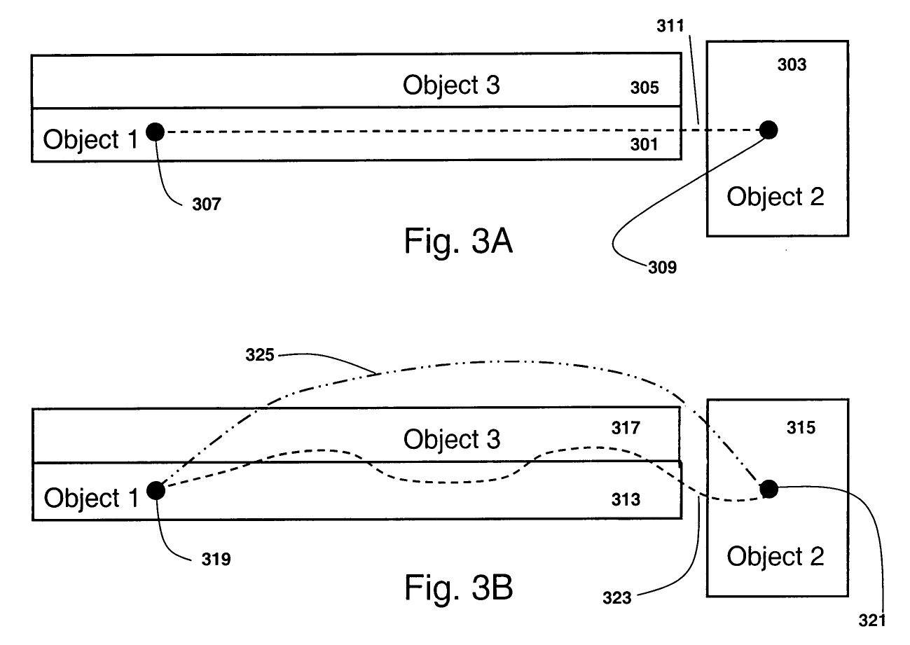

Consider now FIG. 3A, where each object (i.e., Objects 1, Object 2 or Object 3) is activated when the cursor lingers over it for more than a second. This is similar to FIG. 2A, except that there is another object (Object 3, 305) adjacent to Object 1, 301.

The user has just activated Object 1, 301, by putting the cursor at a point on the object, 307. The user now wants to activate Object 2, 303, by putting the cursor over a point, 309, on Object 2. If the user moves the cursor from the point, 307, on Object 1, to the point, 309, on Object 2, the cursor moves along a path, 311, which travels within Object 1. As long as the cursor remains within Object 1, Object 1 is not activated and no other object is activated. For most computer users, this task takes less than a second. For many it can be done without the cursor path wandering outside Object 1.

Many people will not be able to move the cursor in a perfectly straight line from point 307 to point 309. This is illustrated in FIG. 3B.

In FIG. 3B, the user moves the cursor from a point, 319, on Object 1, 313, to a point, 321, on Object 2, 315, along a path, 323. Even though the cursor travels off of Object 1 onto Object 3 and back onto Object 1, if the user moves the cursor at a moderate speed, the cursor (a) does not linger over Object 3 long enough to activate it, and (b) does not linger over Object 1 long enough to re-activate. However, if the user has certain hand-motor-control disabilities, the user will move the cursor along path, 323, in a much slower and deliberate manner. In field trials of the Point-and-Read screen reader, some individuals with motor disabilities took more than 10 seconds to follow a path such as this. For such users, the cursor would move off Object 1 for a couple of seconds onto Object 3 where it would remain for a couple of seconds. Then the cursor would move back onto Object 1 for a couple of seconds, then off again onto Object 3 and on again before reaching Object 2. Each time the cursor moved over Object 3 for a second, it would activate Object 3, even though the user was trying not to do so. Each time the cursor moved back over Object 1 for a second, it would re-activate Object 1, even though the user was trying not to do so. Notice that the alternate path 325 is not as helpful in the situation shown in FIG. 3B as the alternate path 221 was in FIG. 2B.

The present invention teaches that each of the objects in FIG. 3B, (Object 1, Object 2 and Object 3) can have as a precondition to activation, not only the mouse-over event already described, but also a mouse-stop event. To activate Object 1, 313, the user can put the cursor over a point, 319, on the object and either keep his hand steady, or let go of the cursor input device. This can be accomplished by lifting a finger off a track ball, or touch pad. In field trials of the Point-and-Read screen reader, some individuals with hand-motor control disabilities would hold a standard computer mouse between their thumb and forefinger in a light pincher movement, as if it were an eraser. (The Point-and-Read screen reader did not require any clicking of mouse buttons, so many users did not put any fingers over the mouse buttons.) When the users moved the mouse so that the cursor was over a desired object, they would move those two fingers apart, letting go of the mouse without jerking it. To activate Object 2, 315, the user moves the cursor along the path, 323, until the cursor reaches a point, 321, on Object 2, then lets go of the mouse so that the cursor stops. Even if the user moves the cursor very slowly, Object 1 is activated only once—the initial activation. Object 1 is not activated when path 323 crosses it because the cursor never stops during the course of the path over Object 1 (i.e., because the mouse-stop event does not happen, one of the preconditions for re-activation of Object 1 is not met). Likewise, Object 3 is not activated when path 323 crosses it because the cursor never stops during the course of the path over Object 3 (i.e., because the mouse-stop event does not happen, one of the preconditions for re-activation of Object 3 is not met).

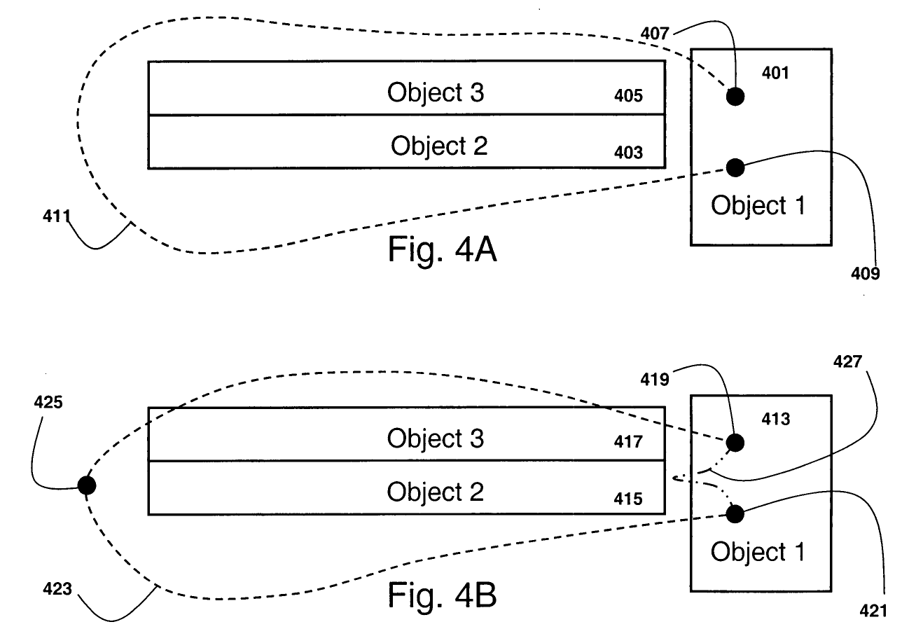

Consider now FIG. 4A, where each object (i.e., Objects 1, Object 2 or Object 3) is activated when the cursor lingers over it for more than a second.

Sometimes the user wants to deliberately re-activate an object. In this example, the user has just activated Object 1, 401, by putting the cursor at a point on the object, 407. The user now wants to re-activate Object 1, by moving the cursor off the object and bringing it back on, without activating any other objects. One way to do this is to move the cursor from the point, 407, on Object 1, to the point, 409, on Object 1, by moving along a path, 411, which travels off Object 1 and back on Object 1 again while avoiding other objects (here Object 2, 403, and Object 3, 405). As long as the cursor avoids Object 2 and Object 3 the user will accomplish the task. For most computer users, this task takes about 2 seconds. For many it can be done without the cursor path wandering onto Object 2 or Object 3.

Many people will not be able to move the cursor as precisely in a curve from point 407 to point 409. This is illustrated in FIG. 4B.

In FIG. 4B, the user moves the cursor from a point, 419, on Object 1, 413, to another point, 421, on Object 1, along a path, 423 which moves off Object 1 and then back on it. Notice that path, 423, happens to cross over Object 3, 417, twice, although it misses Object 2, 415. Even though the cursor travels off over Object 3, if the user moves the cursor at a moderate speed, the cursor does not linger over Object 3 long enough to activate it. However, if the user has certain hand-motor-control disabilities, the user will move the cursor along path, 423, in a much slower and deliberate manner. For such users, the cursor would move onto Object 3 where it would remain over Object 3 for more than a second—then off Object 3 then back on. Each time the cursor moved over Object 3 for a second, it would activate Object 3, even though the user was trying not to do so.

In addition, individuals with hand-motor disabilities may at times have a jerk or shake of their hand that moves the cursor off an object and back on. An example is path 427, which shows the cursor first at a point, 419, on Object 1, 413. A hand tremor or jerk (or someone else bumping the table) sends the cursor off Object 1, along path 427, but the user's “corrective” action brings the cursor back over Object 1 at point 421. Without use of the mouse-stop event, this series of actions (moving the cursor from 419 over path 427 to 421), even though somewhat involuntary, causes Object 1 to be activated twice, even though the user intends only one activation.

The present invention teaches that each of the objects in FIG. 4B, (Object 1, Object 2 and Object 3) can have as a precondition to activation, not only the mouse-over event already described, but also a mouse-stop event. To activate Object 1, 413, the user can put the cursor over a point, 419, on the object and either keep his hand steady, or let go of the cursor input device. This can be accomplished by lifting a finger off a track ball, or touch pad. In field trials of the Point-and-Read Screen reader, some individuals with hand-motor control disabilities would hold a standard computer mouse between their thumb and forefinger in a light pincher movement, as if it were an eraser. (The Point-and-Read Screen reader did not require any clicking of mouse buttons, so many users did not put any fingers over the mouse buttons.) When the users moved the mouse so that the cursor was over a desired object, they would move those two fingers apart, letting go of the mouse without jerking it. To re-activate Object 1, the user moves the cursor along the path, 423, until the cursor reaches another point, 421, on Object 1, then lets go of the mouse so that the cursor stops. Even though the user crosses Object 3, 417, and if the user moves the cursor very slowly, Object 3 will not be activated because the cursor never stops during the course of the path over Object 3 (i.e., because the mouse-stop event does not happen, one of the preconditions for re-activation of Object 3 is not met).

Just as importantly, the present invention teaches that each of the objects can have as a precondition to re-activation that the cursor has a mouse-stop at some point that is a pre-specified minimum distance from the object. Then to reactivate Object 1, 413, the user would have to stop the cursor at some point, 425, that is greater than this pre-specified minimum distance from Object 1, 413. This precondition would reduce or eliminate unintended re-activations, such as when a jerking motion causes the cursor to follow path 427.

In an alternate embodiment, the present invention teaches that each of the objects can have as a precondition to reactivation that the cursor has a mouse-stop at some particular point, 425, on the screen.

In many instances a user can cause the focus to attach to a particular object, program, window, or display area by putting the cursor over it and clicking the left mouse button. This is difficult for some people with hand-motor disabilities. In an alternative embodiment of the present invention, focus can be attached to a particular object, program, window, or display area by moving the cursor over it and then stopping cursor movement for a pre-specified time period. (In some of these instances the focus attaches to a very “generalized” object such as a display area or window, rather than a particularized object such as an image or button.)

So far, this narrative has described how a mouse-stop event can be used as an important programming parameter. The present invention teaches how mouse-stop events reduce inadvertent errors made by computer users who have dexterity, motor-control, or sequencing disabilities.

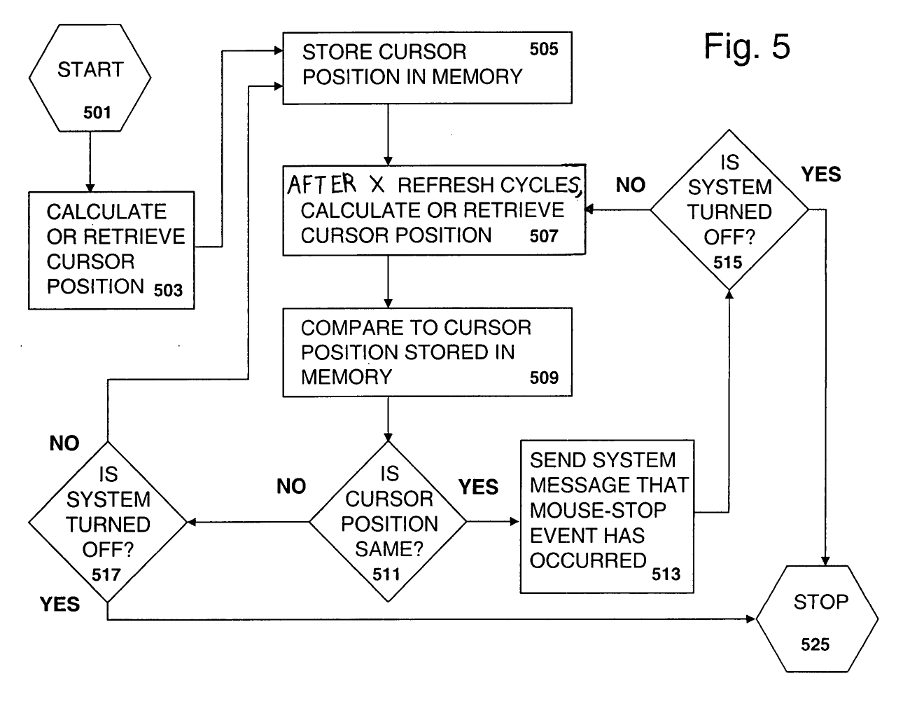

Now consider FIG. 5 which shows a flow chart for a preferred embodiment of the present invention as a software program. The software program could be called an “event handler” type of program—in this instance, a “mouse-stop event handler”.

As soon as the software is initiated, 501, the software retrieves or otherwise calculates the position of the cursor on the computer screen, 503. Preferably, the cursor position is expressed in terms of pixel units in X and Y coordinates. (Alternatively, it can be expressed in scan-lines or any other of the common methods familiar to those knowledgeable in the art.) The software then stores this cursor position (i.e., these coordinates), 505, in one of the computer's memory modules. After x number of refresh cycles for the computer screen, the software again retrieves or calculates the latest cursor position, 507. This latest position is compared to the position stored in memory, 509. If the two coordinates are the same, the cursor has not moved. If the two coordinates are the same, 511, the software sends a system message that the mouse-stop event has occurred, 513. This message can be sent to a particular program using the software, or as a general signal to all modules. If the system and program are still running, 515, on the next x number of refresh cycles, the cursor position is calculated anew, 507 and the process repeats. The program will continue to send a message announcing the mouse-stop event on every x number of screen refresh cycles. If the system or software has been turned off (branch at 515) the process stops, 525.

If at step 511, when the computer compared the latest cursor position to the one stored in memory, the two positions were different, then as long as the system and program are still running, 517, the computer would store the new cursor position in memory, replacing the old position, 505. On the next x number of refresh cycles, 507, the cursor position is calculated anew, and the process repeats. If the system or software has been turned off (branch at 517) the process stops, 525.

In this embodiment, the program sends out a mouse-stop message whenever the cursor has stopped and as long as it remains stationary. The message ends when the cursor starts moving.

In an alternate embodiment, step 507 is altered to read: ON NEXT INSTRUCTION CYCLE CALCULATE OR RETRIEVE CURSOR POSITION. This embodiment of the mouse-stop message is in some manner the complement of the mouse-move message, although unlike the mouse-move message, the mouse-stop message is not associated with any object.

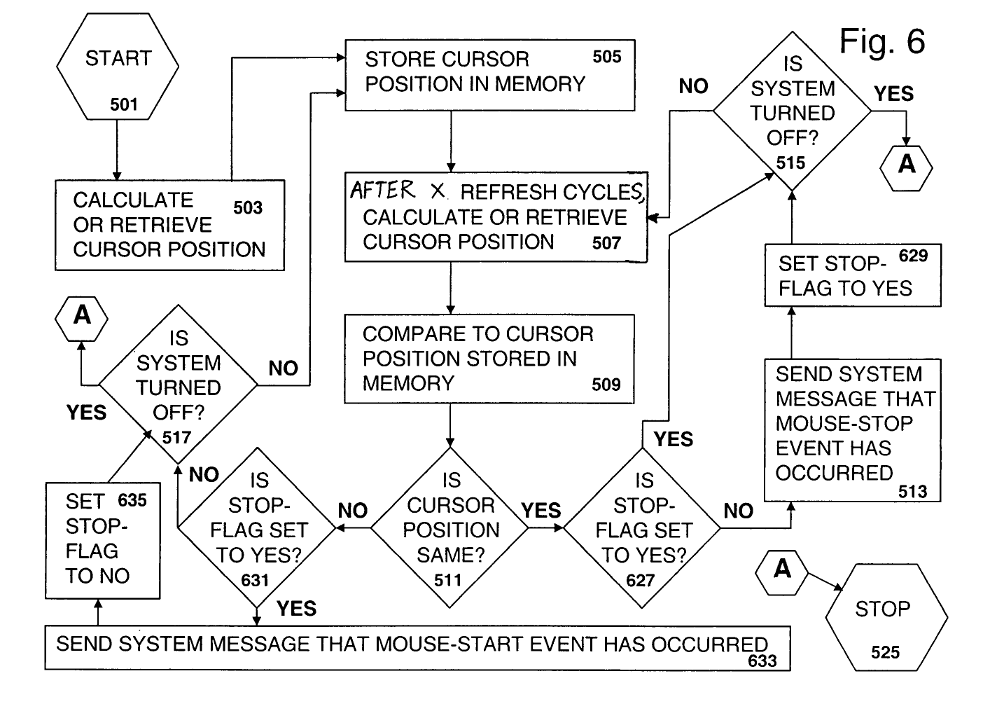

FIG. 6 shows a flow chart for an alternative embodiment. The parts of the process that are the same as in FIG. 5 are labeled with the same numbers. The difference between the two, is that in the process shown in FIG. 6, a mouse-stop message is only sent when the mouse is first detected as having stopped, and a mouse-start message is only sent when the mouse begins moving again. While the cursor is moving, or during an extended period of cursor inaction, the state of the cursor (moving versus stopped) can be ascertained from the state variable “stop-flag”. This variable is set to “yes” when the cursor is stopped, and “no” when the cursor is moving. In other embodiments, this variable is exposed and accessible to polling or calls. In other embodiments, it is only available to the mouse-stop message generator.

Consider now FIG. 6. The first part of the program is the same, that is, calculating the cursor position, 503, storing the position in memory, 505, calculating the new cursor position at the next x number of refresh cycles, 507, and comparing the new position with the one stored in memory, 509 and 511. However, if the two positions are the same, the program checks to see if a variable which the flow chart calls a “stop-flag” has been set to “yes”, 627. This is really a state variable that the program can access that tells it whether the cursor is stopped or not. It could be a “yes/no” variable, “true/false” variable, “1/0” variable or any other variable that records and expresses the binary state of this stopped versus moving attribute. If the stop-flag is set to “yes”, 627, the program does not have to change it since the cursor position is the same, 511. The program does not have to send a mouse-stop message because the state remains the same, so the program proceeds to 515. If the system and/or program is turned off, 515, the process stops, 525. Otherwise the cursor position is recalculated on the next recycle, 507, and the process continues.

Referring back to step 627. If the stop-flag had not been set to “yes”, it means that the cursor has just stopped. Consequently, the program sends a mouse-stop event message to the system, 513 and sets the stop-flag to “yes”, 629. If the system and/or program is turned off, 515, the process stops, 525. Otherwise the cursor position is recalculated on the next recycle, 507, and the process continues.

Referring back to step 511. If the cursor has moved, so that its position has changed from the position in memory, the program first asks if the stop-flag is set to “yes”, 631. If so, it means that the cursor has just started moving since the last x number of refresh cycles, so the program sends a mouse-start message, 633, and sets the flag to “no”, 636. If the system or program is turned off, 517, the process stops, 525, otherwise, the new cursor position is stored in memory, 505, replacing the old position, and the process continues.

Referring back to step 631. If the stop-flag is not been set to “yes”, it means that the cursor was moving at the last calculation of its position, so no message needs to be sent to the system and the stop-flag does not have to be changed. If the system or program is turned off, 517, the process stops, 525, otherwise, the new cursor position is stored in memory, 505, replacing the old position, and the process continues.

In a preferred embodiment, the stop-flag state variables are accessible only to the mouse-stop event handler program. In an alternative embodiment, the stop-flag state variables are accessible to the system and can be polled by other modules.

In an alternative embodiment in which the stop-flag state variables are accessible to other modules, the program does not send any system message, that is, both 513 and 633 are eliminated from the process. In such an embodiment, answering “yes” to the branch at step 631 leads directly to step 635, and answering “no” to the branch at step 627 leads directly to 629.

In alternative embodiments, the recalculation of the cursor position is not done at every x number of refresh cycles, but at another time period (expressed in x number of instruction cycles, frames per second, milliseconds, etc.) which is pre-specified. The pre-specified time period can be hardcoded into the software, or can be set by a programmer, web-page designer, or end user. In essence, an interval timer is set up. Every time the period elapses, a method or function gets called to check the cursor. In any event, in these embodiments, step 507 in FIG. 5 (and/or FIG. 6) is replaced by the similar step 507: “AFTER PRE-SPECIFIED TIME PERIOD CALCULATE OR RETRIEVE CURSOR POSITION”.

Notice that a generalized universal mouse-stop event (or stream of mouse-stop messages) cannot be directly derived from the mouse-move event, because the mouse-move messages are tied to the mouse being over a particular object. Instead a “message hook” would have to intercept all incoming messages of that type regardless of which object they are going to and then examine and process them in order to determine a universal mouse-stop event. Consider the discussion of FIG. 4B, where the mouse-stop (over point 425) most likely occurs over the most generalized objects (e.g. “unoccupied” space within the window of an application).

The mouse-stop and mouse-start events can be added onto objects, so that they become built-in events for DHTML or another coding environment.

In the specific instance where the cursor must be over a particular object and stationary (i.e., both a mouse-stop event and a mouse-over event), the mouse-stop message (or its equivalent) can be derived from a mouse-move type message. (Actual mouse-move messages are not generated or exposed for script use on web pages.) The program must first receive a mouse-move message for an object, then listen for the cessation of mouse-move message. If such cessation occurs before the mouse-leave message, the program generates a mouse-stop message and/or sets the stop-flag to “yes”.

In alternative embodiments, the cursor is still considered “stationary” if it moves only a little bit. This might be a particular setting for a user with only small hand tremors. This “little bit” is pre-specified in various ways known to those skilled in the art, but will be referred to as the “epsilon distance” in this disclosure. In these alternative embodiments, steps 509 and 511 (in FIG. 5 and/or FIG. 6) are replaced. Step 509 is replaced with: “CALCULATE THE DISTANCE (IN PIXELS) BETWEEN THE NEW CURSOR POSITION AND THE ONE IN MEMORY”. Step 511 is replaced with: “IS THE DISTANCE LESS THAN OR EQUAL TO THE PRE-SPECIFIED EPSILON DISTANCE”. These embodiments set the stop-flag state variables to “yes” if the distance is less than or equal to epsilon, and “no” otherwise. These embodiments send a mouse-stop message if the distance is less than or equal to epsilon, and send a mouse-start message otherwise.

In an alternative embodiment, in addition to the changes of the previous paragraph, which allow the pre-specification of an epsilon distance, the flow charts are changed so that step 515 connects to 505 rather than 507. This change allows a very slow cursor “creep” (within epsilon distances) to be considered “stationary.”

In an alternative embodiment, the program not only specifies an epsilon distance, but also places in memory a series of cursor positions and compares the current cursor position to the position a pre-specified number of calculations back. This creates a “running” determination “stationary”.

As described above, the number of refresh cycles or instruction cycles is a value x. The value x is at least one, but would depend upon the speed of the cycles. The value x would only be a small number, such as one, if the refresh cycle or instruction cycle was extremely slow. If the refresh cycle or instruction cycle is a typical value in microseconds or milliseconds, x would be a very large value. The value x should be selected so that the interval of time (e.g., one refresh cycle multiplied by x number of refresh cycles) correlates to the time that a cursor input device (pointing device) would be idle if a user meant to deliberately stop movement of a cursor being controlled by the cursor input device. The value x would be greater for screen displays with very fast refresh cycles or for computers with very fast instruction cycles, compared to screen displays or computers with slower refresh cycles or instruction cycles. The same considerations hold if the sampling time for the cursor input device (such as a mouse, trackball, touch pad, joystick, etc.) was used to define the time interval.

In an alternative embodiment of the present invention, the interval of time is represented by one refresh cycle or one instruction cycle and the cursor is detected as having come to a deliberate stop by detecting when the difference between the current cursor position and the cursor position at the previous refresh cycle or instruction cycle is less than a predetermined value for a predefined number of successive intervals. That is, rather than only sample cursor position after multiple refresh cycles or instruction cycles, cursor position is sampled after each refresh cycle or instruction cycle, but a cursor stop state is not detected until no significant cursor movement is detected for a predefined number of refresh cycles or instruction cycles.

In one preferred embodiment of the present invention, the destinations are objects such as active regions of grammatical units (e.g., sentences) such as described in U.S. patent application Ser. No. 10/084,582 referenced above. In U.S. patent application Ser. No. 10/084,582, a user positions a pointing device over an active region of a grammatical unit, thereby causing the grammatical unit to become automatically highlighted. The grammatical unit is then automatically loaded into a text-to-speech engine, thereby causing the grammatical unit to be automatically spoken. The present invention assists the user in performing this process without unintended errors by inhibiting the action of automatic highlighting, loading of the grammatical unit and automatic speaking of the grammatical unit until it is detected that the cursor has come to a deliberate stop. Other actions described in U.S. patent application Ser. No. 10/084,582, such as navigating to an address of the link, can be inhibited until it is detected that the user deliberately wants the action to occur by detecting that the cursor has come to a deliberate stop. The invention described in U.S. patent application Ser. No. 10/084,582 is thereby enhanced by the present invention. The present invention also has many uses independent of U.S. patent application Ser. No. 10/084,582.

The present invention may be implemented with any combination of hardware and software. If implemented as a computer-implemented apparatus, the present invention is implemented using means for performing all of the steps and functions described above.

The present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

1. A method of detecting when a cursor on a display screen being moved by a pointing device comes to a deliberate stop, the method comprising:
(a) detecting the position of the cursor at successive intervals of time;
(b) at each interval of time, comparing the current cursor position to the cursor position at the previous interval of time; and
(c) detecting that the cursor has come to a deliberate stop by detecting when the difference between the current cursor position and the cursor position at the previous interval of time is less than a predetermined value.

2. The method of claim 1 wherein step (c) further comprises detecting that the cursor has come to a deliberate stop by detecting when the difference between the current cursor position and the cursor position at the previous interval of time is less than a predetermined value for a predefined number of successive intervals.

3. The method of claim 2 wherein the predefined number of successive intervals is a time period of at least about one second.

4. The method of claim 1 further comprising:
(d) upon detection that the cursor has come to a deliberate stop, continuously generating a cursor-stop event signal as long as the cursor remains stopped.

5. The method of claim 4 further comprising:
(e) after detecting that the cursor has come to a deliberate stop, detecting that the cursor has been deliberately moved again by detecting when the difference between the current cursor position and the cursor position at the previous interval of time is greater than a predetermined value; and
(f) stopping the generation of the cursor-stop event signal.

6. The method of claim 1 wherein the interval is a predefined number of refresh cycles of the display screen.

7. The method of claim 1 wherein the interval is a predefined number of instruction cycles.

8. The method of claim 1 wherein step (c) further comprises detecting that the cursor has come to a deliberate stop by detecting when the difference between the current cursor position and the cursor position at the previous interval of time is zero.

9. The method of claim 1 wherein the pointing device is a mouse.

10. The method of claim 1 wherein the cursor position is the x and y coordinates on the display screen in pixel units.

11. A method of causing a predetermined action to occur upon detecting when a cursor being moved by a pointing device to a destination on a display screen comes to a deliberate stop at the destination, the method comprising:
(a) detecting the position of the cursor at successive intervals of time;
(b) at each interval of time, comparing the current cursor position to the cursor position at the previous interval of time;
(c) detecting that the cursor has come to a deliberate stop by detecting when the difference between the current cursor position and the cursor position at the previous interval of time is less than a predetermined value; and
(d) initiating the predetermined action upon detection that:
(i) the cursor has come to a deliberate stop, and
(ii) the cursor is at the destination.

12. The method of claim 11 wherein step (c) further comprises detecting that the cursor has come to a deliberate stop by detecting when the difference between the current cursor position and the cursor position at the previous interval of time is less than a predetermined value for a predefined number of successive intervals.

13. The method of claim 12 wherein the predefined number of successive intervals is a time period of at least about one second.

14. The method of claim 11 further comprising:
(e) upon detection that the cursor has come to a deliberate stop, continuously generating a cursor-stop event signal as long as the cursor remains stopped.

15. The method of claim 14 further comprising:
(e) after detecting that the cursor has come to a deliberate stop, detecting that the cursor has been deliberately moved again by detecting when the difference between the current cursor position and the cursor position at the previous interval of time is greater than a predetermined value; and
(f) stopping the generation of the cursor-stop event signal.

16. The method of claim 11 wherein the interval is a predefined number of refresh cycles of the display screen.

17. The method of claim 11 wherein the interval is a predefined number of instruction cycles.

18. The method of claim 11 wherein step (c) further comprises detecting that the cursor has come to a deliberate stop by detecting when the difference between the current cursor position and the cursor position at the previous interval of time is zero.

19. The method of claim 11 wherein the predefined number of successive intervals is a time period of at least about one second.

20. The method of claim 11 wherein the pointing device is a mouse.

21. The method of claim 11 wherein the destination is a visually discernible object on the display screen and the predetermined action is an activation of the object.

22. The method of claim 11 wherein a mouseover event is used to detect when the cursor is on or near the destination.

23. The method of claim 11 wherein the predetermined action is triggering of a link.

24. The method of claim 11 wherein the predetermined action is initiation of an application.

25. The method of claim 11 wherein the predetermined action is a function call.

26. The method of claim 11 further comprising, after step (d):
(e) detecting new cursor movement using steps (a) and (b); and
(f) allowing for the same predetermined action to occur only if:
(i) the predetermined action has occurred,
(ii) the cursor has moved a predetermined distance from the destination,
(iii) the cursor has been returned to the same destination, and
(iv) it has been detected that the cursor has come to a deliberate stop at the same destination.

27. The method of claim 11 further comprising, after step (d):
(e) detecting new cursor movement using steps (a) and (b); and
(f) allowing for the same predetermined action to occur only if:
(i) the predetermined action has occurred,
(ii) the cursor has moved and has been detected to have come to a deliberate stop at a predetermined distance from the destination,
(iii) the cursor has been returned to the same destination, and
(iv) it has been detected that the cursor has come to a deliberate stop at the same destination

28. The method of claim 11 further comprising, after step (d):
(e) detecting new cursor movement using steps (a) and (b); and
(f) allowing for the same predetermined action to occur only if:
(i) the predetermined action has occurred,
(ii) the cursor has moved to a predetermined location on the display screen,
(iii) the cursor has been returned to the same destination, and
(iv) it has been detected that the cursor has come to a deliberate stop at the same destination.

29. A method of detecting movement states of a cursor on a display screen, the movement states including (i) a cursor stop state, and (ii) a cursor moving state, the cursor being moved by a pointing device, the method comprising:
(a) detecting the position of the cursor at successive intervals of time;
(b) at each interval of time, comparing the current cursor position to the cursor position at the previous interval of time; and
(c) detecting a cursor stop state when the difference between the current cursor position and the cursor position at the previous interval of time is less than a predetermined value, and detecting a cursor movement state when the difference between the current cursor position and the cursor position at the previous interval of time is equal to or greater than a predetermined value.

30. The method of claim 29 wherein step (c) further comprises detecting a cursor stop state by detecting when the difference between the current cursor position and the cursor position at the previous interval of time is less than a predetermined value for a predefined number of successive intervals, and detecting a cursor movement state by detecting when the difference between the current cursor position and the cursor position at the previous interval of time is equal to or greater than a predetermined value for a predefined number of successive intervals.

31. The method of claim 30 wherein the predefined number of successive intervals is a time period of at least about one second.

32. The method of claim 29 further comprising:
(d) upon detecting a cursor stop state, continuously generating a cursor-stop event signal as long as the cursor remains stopped.

33. The method of claim 29 wherein the interval is a predefined number of refresh cycles of the display screen.

34. The method of claim 29 wherein the interval is a predefined number of instruction cycles.

35. The method of claim 29 wherein step (c) further comprises detecting a cursor stop state by detecting when the difference between the current cursor position and the cursor position at the previous interval of time is zero, and detecting a cursor movement state by detecting when the difference between the current cursor position and the cursor position at the previous interval of time is not zero.

36. The method of claim 29 wherein the pointing device is a mouse.

37. The method of claim 29 wherein the cursor position is the x and y coordinates on the display screen in pixel units.

38. An article of manufacture for detecting when a cursor on a display screen being moved by a pointing device comes to a deliberate stop, the article of manufacture comprising a computer-readable medium holding computer-executable instructions for performing a method comprising:
(a) detecting the position of the cursor at successive intervals of time;
(b) at each interval of time, comparing the current cursor position to the cursor position at the previous interval of time; and
(c) detecting that the cursor has come to a deliberate stop by detecting when the difference between the current cursor position and the cursor position at the previous interval of time is less than a predetermined value.

39. The article of manufacture of claim 38 wherein step (c) further comprises detecting that the cursor has come to a deliberate stop by detecting when the difference between the current cursor position and the cursor position at the previous interval of time is less than a predetermined value for a predefined number of successive intervals.

40. The article of manufacture of claim 39 wherein the predefined number of successive intervals is a time period of at least about one second.

41. The article of manufacture of claim 38 wherein the computer-executable instructions perform a method further comprising:
(d) upon detection that the cursor has come to a deliberate stop, continuously generating a cursor-stop event signal as long as the cursor remains stopped.

42. The article of manufacture of claim 39 wherein the computer-executable instructions perform a method further comprising:
(e) after detecting that the cursor has come to a deliberate stop, detecting that the cursor has been deliberately moved again by detecting when the difference between the current cursor position and the cursor position at the previous interval of time is greater than a predetermined value; and
(f) stopping the generation of the cursor-stop event signal.

43. The article of manufacture of claim 38 wherein the interval is a predefined number of refresh cycles of the display screen.

44. The article of manufacture of claim 38 wherein the interval is a predefined number of instruction cycles.

45. The article of manufacture of claim 38 wherein step (c) further comprises detecting that the cursor has come to a deliberate stop by detecting when the difference between the current cursor position and the cursor position at the previous interval of time is zero.

46. The article of manufacture of claim 38 wherein the pointing device is a mouse.

47. The article of manufacture of claim 38 wherein the cursor position is the x and y coordinates on the display screen in pixel units.

48. An article of manufacture for causing a predetermined action to occur upon detecting when a cursor being moved by a pointing device to a destination on a display screen comes to a deliberate stop at the destination, the article of manufacture comprising a computer-readable medium holding computer-executable instructions for performing a method comprising:
(a) detecting the position of the cursor at successive intervals of time;
(b) at each interval of time, comparing the current cursor position to the cursor position at the previous interval of time;
(c) detecting that the cursor has come to a deliberate stop by detecting when the difference between the current cursor position and the cursor position at the previous interval of time is less than a predetermined value; and
(d) initiating the predetermined action upon detection that:
(i) the cursor has come to a deliberate stop, and
(ii) the cursor is at the destination.

49. The article of manufacture of claim 48 wherein step (c) further comprises detecting that the cursor has come to a deliberate stop by detecting when the difference between the current cursor position and the cursor position at the previous interval of time is less than a predetermined value for a predefined number of successive intervals.

50. The article of manufacture of claim 49 wherein the predefined number of successive intervals is a time period of at least about one second.

51. The article of manufacture of claim 48 wherein the computer-executable instructions perform a method further comprising:
(e) upon detection that the cursor has come to a deliberate stop, continuously generating a cursor-stop event signal as long as the cursor remains stopped.

52. The article of manufacture of claim 51 wherein the computer-executable instructions perform a method further comprising:
(e) after detecting that the cursor has come to a deliberate stop, detecting that the cursor has been deliberately moved again by detecting when the difference between the current cursor position and the cursor position at the previous interval of time is greater than a predetermined value; and
(f) stopping the generation of the cursor-stop event signal.

53. The article of manufacture of claim 48 wherein the interval is a predefined number of refresh cycles of the display screen.

54. The article of manufacture of claim 48 wherein the interval is a predefined number of instruction cycles.

55. The article of manufacture of claim 48 wherein step (c) further comprises detecting that the cursor has come to a deliberate stop by detecting when the difference between the current cursor position and the cursor position at the previous interval of time is zero.

56. The article of manufacture of claim 48 wherein the predefined number of successive intervals is a time period of at least about one second.

57. The article of manufacture of claim 48 wherein the pointing device is a mouse.

58. The article of manufacture of claim 48 wherein the destination is a visually discernible object on the display screen and the predetermined action is an activation of the object.

59. The article of manufacture of claim 48 wherein a mouseover event is used to detect when the cursor is on or near the destination.

60. The article of manufacture of claim 48 wherein the predetermined action is triggering of a link.

61. The article of manufacture of claim 48 wherein the predetermined action is initiation of an application.

62. The article of manufacture of claim 48 wherein the predetermined action is a function call.

63. The article of manufacture of claim 48 wherein the computer-executable instructions perform a method further comprising, after step (d):
(e) detecting new cursor movement using steps (a) and (b); and
(f) allowing for the same predetermined action to occur only if:
(i) the predetermined action has occurred,
(ii) the cursor has moved a predetermined distance from the destination,
(iii) the cursor has been returned to the same destination, and
(iv) it has been detected that the cursor has come to a deliberate stop at the same destination.

64. The article of manufacture of claim 48 wherein the computer-executable instructions perform a method further comprising, after step (d):
(e) detecting new cursor movement using steps (a) and (b); and
(f) allowing for the same predetermined action to occur only if:
(i) the predetermined action has occurred,
(ii) the cursor has moved and has been detected to have come to a deliberate stop at a predetermined distance from the destination,
(iii) the cursor has been returned to the same destination, and
(iv) it has been detected that the cursor has come to a deliberate stop at the same destination

65. The article of manufacture of claim 48 wherein the computer-executable instructions perform a method further comprising, after step (d):
(e) detecting new cursor movement using steps (a) and (b); and
(f) allowing for the same predetermined action to occur only if:
(i) the predetermined action has occurred,
(ii) the cursor has moved to a predetermined location on the display screen,
(iii) the cursor has been returned to the same destination, and
(iv) it has been detected that the cursor has come to a deliberate stop at the same destination.

66. An article of manufacture for detecting movement states of a cursor on a display screen, the movement states including (i) a cursor stop state, and (ii) a cursor moving state, the cursor being moved by a pointing device, the article of manufacture comprising a computer-readable medium holding computer-executable instructions for performing a method comprising:
(a) detecting the position of the cursor at successive intervals of time;
(b) at each interval of time, comparing the current cursor position to the cursor position at the previous interval of time; and
(c) detecting a cursor stop state when the difference between the current cursor position and the cursor position at the previous interval of time is less than a predetermined value, and detecting a cursor movement state when the difference between the current cursor position and the cursor position at the previous interval of time is equal to or greater than a predetermined value.

67. The article of manufacture of claim 66 wherein step (c) further comprises detecting a cursor stop state by detecting when the difference between the current cursor position and the cursor position at the previous interval of time is less than a predetermined value for a predefined number of successive intervals, and detecting a cursor movement state by detecting when the difference between the current cursor position and the cursor position at the previous interval of time is equal to or greater than a predetermined value for a predefined number of successive intervals.

68. The article of manufacture of claim 67 wherein the predefined number of successive intervals is a time period of at least about one second.

69. The article of manufacture of claim 66 wherein the computer-executable instructions perform a method further comprising:
(d) upon detecting a cursor stop state, continuously generating a cursor-stop event signal as long as the cursor remains stopped.

70. The article of manufacture of claim 66 wherein the interval is a predefined number of refresh cycles of the display screen.

71. The article of manufacture of claim 66 wherein the interval is a predefined number of instruction cycles.

72. The article of manufacture of claim 66 wherein step (c) further comprises detecting a cursor stop state by detecting when the difference between the current cursor position and the cursor position at the previous interval of time is zero, and detecting a cursor movement state by detecting when the difference between the current cursor position and the cursor position at the previous interval of time is not zero.

73. The article of manufacture of claim 66 wherein the pointing device is a mouse.

74. The article of manufacture of claim 66 wherein the cursor position is the x and y coordinates on the display screen in pixel units.
